(19) United States
(12) Patent Application Publication
(10) Pub. No.: US 2004/0105953 A1
(43) Pub. Date: Jun. 3, 2004

(54) Double-walled insulating member

(76) Inventor: Ekkehard Nowara, Krummhorn, DE (US)

Correspondence Address: Proskauer Rose LLP, Room 17-25, 1585 Broadway, New York, NY, 10036, US

(21) Appl. No.: 10/618,364

(22) Filed: Jul. 10, 2003

Related U.S. Application Data
(63) Continuation of application No. 09/746,740, filed on Dec. 21, 2000, now abandoned.

(30) Foreign Application Priority Data
Jan. 6, 2000 (DE) 100 00 260.9-44

(51) Int. Cl. B32B 1/04

(52) U.S. Cl. 428/69; 428/122; 428/71

(57) ABSTRACT

The invention relates to an insulating member and a method of producing said member. Such an insulating member consists of two sheet metal walls 1, 2, a sealing profile 3 connecting the walls 1, 2 hermetically at the edge, and dimensionally stable sealing material 4, more particularly an open-pored cellular material, which is accommodated in the evacuated cavity formed by the walls 1, 2 and the sealing profile 3 hermetically connected thereto. The sealing material 4 is dimensionally stable and supports the walls 1, 2. To improve the insulating effect of the insulating member in the edge zone also, the hermetic connection of the sealing profile 3 to the walls 1, 2 takes the form of a heat sealing, and the sealing profile itself does not consist of sheet metal, but of a material having a lower thermal conductivity, low vapour permeability and satisfactory hot sealing properties. Such an insulating member is produced in a vacuum chamber with the cavity at first open and furnished with the insulating material 4, whereafter the cavity is closed and the edge zones are hot sealed in vacuo.

The invention relates to a double-walled insulating member in the form of a plate, bowl, pot or box, whose two sheet metal walls, jointly with a sealing profile connected hermetically between the metal sheets at their enclosing edges, enclose an evacuated cavity in which insulating material supporting the walls is disposed.

Such an insulating member in the form of a plate is known (“Forum” ThyssenKrupp Technical Papers 2/1999, pages 42 to 45, ISSN 1438-5635). In that insulating member the U-shaped sealing profile, taking the form of a frame, and also the wall are made from sheet metal. The walls and the sealing profile are metallically welded to one another at their edges. Due to the metallic sealing profile and the metallic welding connection the effect of the edge connection of the walls and the sealing profile are of essential importance to determine the heat transfer coefficient of such an insulating member. To reduce this effect to the maximum extent the sealing profile is optimised—i.e., it is as thin as possible.

To produce such an insulating member the individual elements, namely the walls, the sealing profile and the insulating material are combined with one another, whereafter the walls are welded to the sealing profile. Then the cavity is evacuated via an evacuating flange provided in one of the walls. To enable the cavity to be evacuated in as optimum a manner as possible, the insulating material uses a microporous supporting material with as high a proportion of pores as possible—up to 90% of the cavity volume. As a result, thermal conductivity can be reduced by a factor of more than 10 with a residual gas pressure lower than 0.1 mbar in comparison with atmospheric pressure.

It is an object of the invention to provide a double-walled insulating member of the kind specified which has a lower thermal conductivity than conventional insulating members and which can be more readily produced, at least if it takes the form of a plate or bowl.

This problem is solved in double-walled insulating member of the kind specified by the features that the wall connection of the sealing profile, which consists of a non-metallic material of low thermal conductivity, low vapour permeability and satisfactory hot sealing properties, takes the form of a large-area hot seal.

Due to its novel edge connection of the walls, the insulating member according to the invention, which can take various forms, is characterised by improved insulating capacity, since the abandonment of the metallic welding connection which was customary with a metallic sealing profile enables the edge connections of the walls to be optimised via the selection of the material of the sealing profile so as to achieve as low a thermal conductivity as possible, while at the same time, due to the large distance from atmosphere to the cavity through the hot sealing seam and the low vapour permeability of the sealing profile, the large-area hot seal ensures a permanent high vacuum. The low vapour permeability of the sealing profile can be obtained in a simple manner by the feature that a metal foil is integrated as a vapour barrier in the sealing profile.

Since the metal foil is intended solely to act as a vapour barrier and has no metallic connection to the walls, it cannot act as a thermal bridge between the walls.

In one embodiment of the invention the sealing profile has a substantially U-shaped cross-section and is filled with a stiffening material. In this way the edge zone of the insulating member can also be stiffened in a problem-free manner, so that even in this otherwise unsupported zone the insulating member can better withstand mechanical loadings. Another advantage is that coupling elements for adjacent insulating members can be embedded in the stiffening material. This incorporation of coupling elements enables the joining sheets to be connected, without the coupling elements themselves acting as a thermal bridge. They also make possibly a blind connection between adjacent insulating members.

The quality of insulation of the insulating member essentially depends on the structure of the insulating material. In addition to its wall-supporting function, necessary because of the vacuum in the cavity, the insulating material should therefore have as small a volume as possible. It should also allow the build-up of as high a vacuum as possible. Microporous supporting materials have been provided to be very useful whose proportion of pores reaches up to 90% of the cavity volume. If a cellular material is used, it should be open-pored.

A number of possibilities which can be used singly or in combination can be adopted for the hot seal between the walls and the sealing profile. Preferably the walls are provided with a hot-sealable coating at least in the zone of the hot seal. Correspondingly, the sealing profile can also be provided with a hot sealable coating or be made entirely from a hot-sealable material. However, hot-sealable foils can also be interposed between the walls and the sealing profile.

While it is relatively expensive to produce conventional insulating members in the form of plates, since the plates must first be completed and metallically welded to their edge zones, whereafter the cavity between the sheets and the sealing profile can be evacuated via an opening in one of the walls, the invention proposes a different method. In the method according to the invention the wall connection is hot-sealed in vacuo on the insulating body put together from its individual parts and evacuated. This has the advantage that a vacuum can readily be set up even with the cavity still open, for example, by the completed, but not yet welded insulating member being accommodated in a vacuum chamber. Hot sealing is then performed in the vacuum chamber. It is therefore superfluous to provide a vacuum connection in a wall which is subsequently closed. Nor is there any longer a need to fix the elements of the insulating member by a weld to achieve mechanical coherence, since the hot sealing is performed in vacuo and the elements bear against one another due to the pressure with which they are loaded. At the same time, the hot-sealed seam merely serves to seal the evacuated cavity.

In one embodiment of the invention this is achieved by the features that after the wall has been furnished with the sealing profile and the insulating material, these elements are evacuated in a chamber, and only then is the second wall provided during maintenance of the vacuum.

The invention will now be explained in greater detail with reference to drawings, which show:

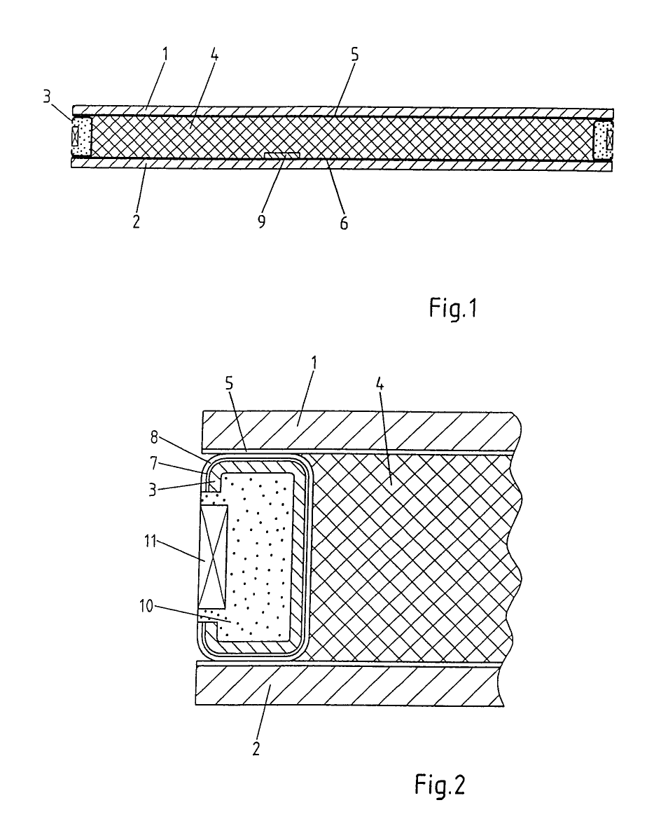

FIG. 1 a cross-section through a double-walled insulating member in the form of a plate,

FIG. 2 the insulating member shown in FIG. 1 in cross-section in the edge zone and to an enlarged scale, and

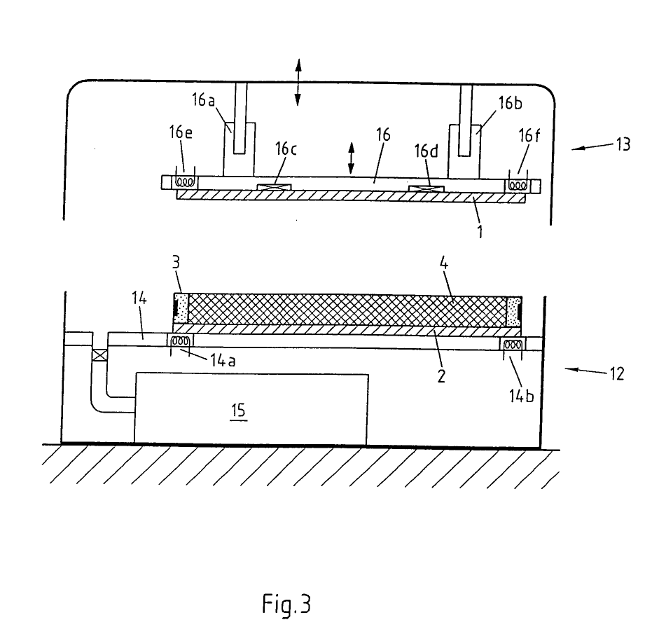

FIG. 3 a diagram of an insulation for producing the insulating member shown in FIG. 1.

Referring to FIGS. 1 and 2, an insulating member takes the form of a sheet. Other shapes of insulating members are possible, such as bowls, arched along one or two axes, pots of circular, oval or angular cross-section, or boxes of parallelepipedic shape. Their shape and assembly in modular construction depends on the required field of application. Examples which maybe mentioned are lorry superstructures, containers, transport boxes, cold storage cells, facade elements and refrigeration apparatuses.

As shown in FIGS. 1 and 2, an insulating member in the form of a plate consists of two walls 1, 2 of steel sheet, more particularly of special quality, an enclosing sealing profile 3 taking the form of a frame, and insulating material 4 accommodated in a cavity enclosed by the walls 1, 2 and the sealing profile 3. In the embodiment illustrated, on the inside, at least in the zone of the sealing profile 3, the walls 1, 2 are even coated over their whole area with a hot-sealable material 5, 6. The substantially U-shaped sealing profile 3 is made of plastics and is coated as a vapour barrier with a metal foil 7 and with a hot-sealable material 8, just like the walls 1, 2.

Since the sealing profile 3 is substantially U-shaped a large-area hot-sealing seam is produced on its arms which represents a long distance of the order of magnitude of 20 mm from atmosphere to the cavity. As a result, and due to the metal foil 7 situated as a vapour barrier in the direction of the cavity, no air can enter the cavity from the atmosphere.

The insulating material 4 in the cavity is an open-pored cellular material of high rigidity. The cellular material has two functions. On the one hand it supports the walls 1, 2 loaded by atmospheric pressure in relation to the evacuated cavity. On the other hand with the open-pored cellular material the cavity can be completely evacuated, so that the insulating effect of the cavity is optimum. Lattice material 9 can also be provided in the cavity for the absorption of residual air.

The sealing profile 3 is filled with dimensionally stable insulating material 10, something which improves the insulating effect in the zone of the edge connection of the walls 1, 2, which is critical in this respect. The insulating material 10 also serves for the retention of coupling elements 11 embedded therein for the connection of adjacent insulating members.

The insulating member in plate form is preferably produced in a vacuum chamber. FIG. 3 shows such a vacuum chamber. The vacuum chamber consists of a lower chamber part 12 and an upper chamber part 13 taking the form of a vertically adjustable hood. The lower chamber part 12 has a bearing table 14 below which a vacuum pump 15 is accommodated. The bearing table 14 is provided with heating elements 14a, 14b.

Disposed on the upper part 13 is a retaining plate 16 suspended by lifting elements 16a, 16b and equipped with solenoids 16c, 16d. Heating elements 16e, 16f are also disposed in the retaining plate 16.

For production purposes first one wall 2 with frame-like sealing profile 3 laid thereon and sealing material 4 incorporated therein is so laid on the bearing table 14 that the sealing profile 3 registers with the heating elements 14a, 14b. The other wall 1 is laid on the retaining plate 16 and retained by the solenoids 16c, 16d. Then the hood-like upper part 13 is moved downwards and connected hermetically to the lower part 12. When the retaining plate 16 is raised the vacuum pump 15 is started and the entire vacuum chamber placed under vacuum. At the same time, due to the open-pored nature of the cellular material the insulating material 4 consisting thereof can be evacuated in a problem-free manner. After the required vacuum has built up in the chamber, by means of the lifting elements 16a, 16b the wall 1 is laid and pressed on to the sealing profile 3 and the insulating material 4. Then the heating elements 14a, 14b, 16e, 16f are activated and the large-area hot sealing is performed on both sides. When the hot-sealed surfaces have cooled, the insulating member is ready.

1. A double-walled insulating member in the form of a plate, bowl, pot or box, whose two sheet metal walls (1, 2), jointly with a sealing profile (3) connected hermetically between the metal sheets at their enclosing edges, enclose an evacuated cavity in which insulating material (4) supporting the walls (1, 2) is disposed, characterised in that the wall connection of the sealing profile (3), which consists of a non-metallic material of low thermal conductivity, low vapour permeability and satisfactory hot sealing properties, takes the form of a large-area hot seal.

2. An insulating member according to claim 1, characterised in that a metal foil (7) is integrated as a vapour barrier in the sealing profile (3).

3. An insulating member according to claims 1 or 2, characterised in that the sealing profile (3) has a substantially U-shaped cross-section and is filled with a stiffening material (10).

4. An insulating member according to claim 3, characterised in that coupling elements (11) for adjacent insulating members are embedded in the stiffening material (10).

5. An insulating member according to one of claims 1 to 4, characterised in that the stiffening material (10) has a low thermal conductivity.

6. An insulating member according to one of claims 1 to 3, characterised in that the insulating material (4) is an open-pored cellular material.

7. An insulating member according to one of claims 1 to 6, characterized in that the walls (1, 2) are provided with a hot-sealable coating (5, 6) at least in the zone of the hot seal.

8. An insulating member according to one of claims 1 to 7, characterized in that at least in the zone of the hot-seal the sealing profile (3) is provided with a hot sealable coating (8) or consists of a hot-sealable material.

9. A method of making an insulating member according to one of claims 1 to 5, characterised in that the wall connection is hot-sealed in vacuo on the insulating body put together from its individual parts and evacuated.

10. A method of producing an insulating member in the form of a plate or bowl according to claim 9, characterised in that after the wall has been furnished with the sealing profile and the insulating material, these elements are evacuated in a chamber, and only then is the second wall provided during maintenance of the vacuum.
